(19) United States
(12) Patent Application Publication
(10) Pub. No.: US 2020/0401662 A1
(43) Pub. Date: Dec. 24, 2020

(54) TEXT CLASSIFICATION WITH SEMANTIC GRAPH FOR DETECTING HEALTH CARE POLICY CHANGES

(71) Applicant: INTERNATIONAL BUSINESS MACHINES CORPORATION, ARMONK, NY (US)

(72) Inventors: Feng-wei Chen, Cary, NC (US); John Segrave-Daly, Glenageary (IE); Conor Patrick Cullen, Clontarf (IE)

(21) Appl. No.: 16/448,658

(22) Filed: Jun. 21, 2019

(51) Int. Cl. G06F 17/27

(52) U.S. Cl. CPC G06F 17/2785

(57) ABSTRACT

According to one embodiment, a method, computer system, and computer program product for detecting and communicating semantic changes in revisions of two or more text documents is provided. The present invention may include converting two or more text documents into semantic graphs; comparing the semantic graphs, to identify a the semantic differences between the text documents, wherein the comparing entails applying both a coarse-grained differencing method and a fine-grained differencing method to identify of the changes between equivalent sections of the text documents; and transmitting, based on user preferences, a subset of the semantic differences to one or more user devices.

### BACKGROUND

The present invention relates, generally, to the field of computing, and more particularly to computational semantics.

Computational semantics is a field of computing concerned with automating the process of constructing and reasoning with meaningful representations of natural language expressions. Computational semantics may be considered an important component of natural language processing, and is crucial in enabling computers to parse and understand the meaning of natural language, and as such has the potential to significantly increase the power of computers in both interfacing with humans and in assisting humans in language processing tasks.

### SUMMARY

According to one embodiment, a method, computer system, and computer program product for detecting and communicating semantic changes in revisions of two or more text documents is provided. The present invention may include converting two or more text documents into semantic graphs; comparing the semantic graphs, to identify a the semantic differences between the text documents, wherein the comparing entails applying both a coarse-grained differencing method and a fine-grained differencing method to identify of the changes between equivalent sections of the text documents; and transmitting, based on user preferences, a subset of the semantic differences to one or more user devices.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a change detection process according to at least one embodiment;

FIG. 3 is an operational flowchart illustrating a comparison process according to at least one embodiment;

FIG. 4 is a block diagram illustrating the architecture of a change detection system according to at least one embodiment;

FIG. 5 is an operational flowchart illustrating a semantic graph according to at least one embodiment;

FIG. 6 is a block diagram of internal and external components of computers and servers depicted in FIG. 1 according to at least one embodiment;

FIG. 7 depicts a cloud computing environment according to an embodiment of the present invention; and

FIG. 8 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to computational semantics. The following described exemplary embodiments provide a system, method, and program product to, among other things, identify areas within a text document that have changed in a revision or update, identify the precise semantic nature of the changes, and anchor the changes to the exact policy text that describes the changes. Therefore, the present embodiment has the capacity to improve the technical field of computational semantics by automatically constructing database queries for a user based on semantic differences to reduce a large knowledge graph of policy rules extracted from text down to a subset of interest to a user, in a form that can be easily shared, saved, and repeated across different domains. The embodiment realizes further advantages in removing noise from the subset of changes in the text, by removing the set of nodes and vertices in the knowledge graph that were incorrectly identified as policy rules during knowledge extraction, thereby improving the accuracy of query results and making the subset easier and more tractable for users.

As previously described, computational semantics is a field of computing concerned with automating the process of constructing and reasoning with meaningful representations of natural language expressions. Computational semantics may be considered an important component of natural language processing, and is crucial in enabling computers to parse and understand the meaning of natural language, and as such has the potential to significantly increase the power of computers in both interfacing with humans and in assisting humans in language processing tasks.

The responsibilities of healthcare providers in a public healthcare system are described in government healthcare policy documents. These documents are complex, describing many conditions and rules under which healthcare service providers may provide services and receive reimbursement from the state. Often, there is no one source of policy rules that a given provider must be aware of, but rather a collection of related policy documents that lay out dozens of categories of citizens and the different services for which the state provides coverage. For example, a document may describe different types of physical therapy or audiology services, and how much each of those services each category of citizen (child, adolescent, etc.) may receive. As a further example, two exemplary excerpts of text documents pertaining to a medical insurance policy, Excerpt A and Excerpt B, are provided below. Excerpt B is a later revision of Excerpt A, and the changes between them are in bold. Excerpt A is worded and formatted as follows:
As of Jul. 1, 2007, providers of physician and practitioner services; outpatient services (including outpatient hospitals, federal qualified health centers, rural health centers and dialysis centers); emergency dental services, independent laboratory and x-ray services; medical supply services; hospice and home health services; and emergency transportation services will be reimbursed at 60% of the appropriate Medicaid reimbursement. [Effective Jul. 30, 2007]
As of Nov. 1, 2006, pharmacy claims are reimbursed at 70% of the appropriate Medicaid reimbursement. [Effective Jul. 30, 2007]
   Excerpt B is worded and formatted as follows:
As of Apr. 15, 2009, providers of physician and practitioner services; outpatient services (including outpatient hospitals, federal qualified health centers, rural health centers and dialysis centers); emergency dental services, independent laboratory and x-ray services; medical supply services; hospice and home health services; and emergency transportation services will be reimbursed at 65% of the appropriate Medicaid reimbursement. As of Apr. 15, 2009, pharmacy claims are reimbursed at 75% of the appropriate Medicaid reimbursement.
   Excerpt A and Excerpt B are very similar, but they have formatting differences that may foil a side-by-side comparison.

In addition to the complex language, structure, and cross-references in these policy documents, providers are also expected to keep up to date with changes to these policies, changes that may occur frequently, in some cases every few months or even weeks. These ongoing changes to already-complex policy pose a significant challenge for healthcare providers. To be reimbursed for the services they provide, they must ensure those services are compliant with current policy. However, it is difficult to identify which policies have changed over a given period of time, and what the specific changes were. Policy updates are generally not provided in the same format as the original policy, so it is not possible to compare two versions of a policy to identify changes.

Existing attempts at identifying changes largely rise only to the level of providing a textual comparison of the documents, for instance by attempting to identify and compare policy rules that follow certain semantic structures, but lack any semantic insight into the meaning of a change. It is precisely that semantic insight into policy changes or updates that policy stakeholders need; textual comparison only works well when two documents possess nearly identical structure and nearly identical wording. For large documents spanning hundreds of pages, this is rarely the case. The introduction of a small number of new paragraphs, tables, or images can completely disrupt a textual comparison process. Even in successful cases, textual comparison requires a human to take the time to read through the textual differences and identify the changes that matter (for instance, a rate change) in a sea of structural, grammatical, and other meaningless differences. Once a human understands the changes that matter, the human may then have to document the necessary changes to business rules and potentially to implement these new rules in code. Very little of this process can be automated, shared, or repeated across different domains. As such, it may be advantageous to, among other things, implement a system that compares two revisions of the same document or policy (for example, a dental Medicaid policy in 2017 and 2018) to discover key semantic differences (for example, a change in reimbursement rate for a service) and to make these differences actionable to a user who is non-technical and cannot construct technical queries (such as via SPARQL).

According to one embodiment, the invention is a system for converting text documents into semantic graphs using a multi-dimensional semantic graph analyzer, and comparing the semantic graphs to identify semantic differences between the text documents.

In some embodiments, semantics or semantic differences may refer to changes in meaning, for instance where a reimbursement rate changes from 70% to 75%. The change from 70% to 75%, devoid of context, may be a mere numerical or textual difference; understanding that this changed numbers pertains to a reimbursement rate even though the number may appear in different contexts, or may be described in terms other than a reimbursement rate in the text where it appears (i.e. “refund” in one text and “reimbursement rate” in an updated text), is what makes a difference semantic. In other words, a semantic difference may comprise a textual change and the attached meaning of the textual change.

In some embodiments, the multi-dimensional semantic graph analyzer may employ a domain-specific ontology, where the domain specific ontology pertains to the field associated with the text documents to be compared. For instance, when the texts are in the medical insurance field, the system may retrieve an ontology pertaining to medical insurance. The ontology or ontologies may be pre-defined by subject matter experts, and may include a representation, formal naming, and definition of the properties and ranges that substantiate a domain.

In some embodiments, the semantic graph may be a knowledge graph that represents concepts expressed in the texts (for example, Physiotherapy Service, Unit Limitations, et cetera) as well as the relationships between those concepts (for example, that there is a limit to the units of services that a provider can claim for Physiotherapy Services and the value of that Unit Limitation is 20 units). The structure of the semantic graph may be provided by an ontology that is defined by subject matter experts, for instance subject matter experts in the medical insurance field. For example, the ontology may define that different services, such as a Healthcare Service, each possess Unit Limitations and that those limits are expressed as integer values. Based on the ontology, the system may extract a semantic graph for every place in the policy text where Unit Limitations are mentioned in relation to a Healthcare Service—potentially hundreds/thousands of information points. In some embodiments, to improve accuracy and reduce noise, the system may use a semantic graph's relative position in the file, as well as the user's interests, to filter out incorrect nodes and vertices identified incorrectly as policy rules.

In some embodiments, the multi-dimensional graph analyzer may compare text documents by classifying the domain, property, and range into a multi-dimensional format, and then use the dimensions to conduct two types of differencing, fine-grained and coarse-grained; the coarse-grained differencing identifies equivalent sections of the document to compare, and the fine-grained differencing identifies very precise semantic differences.

In some embodiments, coarse-grained differencing may include straightforward text-similarity scoring to determine which sections from the two documents being compared are roughly identical. The strength of text-similarity scoring is that it can establish which sections in the two documents are equivalent, even if differences exist. Since the sections can be quite large (on the order of pages) depending on the text documents in question, and the corresponding knowledge graphs can be quite large, coarse-grained differencing helps to map sections of the documents to each other so that changes can be more easily tracked.

In some embodiments, fine-grained differencing may include using dimensional information encoded in the semantic graphs to identify candidate sub-graphs of interest within the similar sections identified by the coarse-grained differencing. In some embodiments, the system may identify sub-graphs of interest by automatically constructing database queries to select sub-graphs belonging to a dimension that a user has previously expressed interest in (for instance, a user may specify that she is interested in identifying differences that are ‘Financial’ in nature).

In some embodiments, the multi-dimensional graph analyzer may generate a summary micro semantic graph which encapsulates only the semantic differences between two policy revisions, while also retaining the original context of the documents. In some embodiments, the system may transmit the summary micro semantic graph to the mobile device of a user, or may display the summary micro semantic graph on a device in response to a user request.

In some embodiments, the user may define their interest domain, for example through a configuration file, and the system may watch for the defined types of important policy changes. In some embodiments, the system may trigger an alert on a user's device to inform a user of changes to a text document. In some embodiments, the system may send the user an alert if the changes fall within the user's selected field of interest.

In some embodiments, the system may accept a corpus of policy documents and generate a set of all semantic differences between revisions of policies within that corpus.

In some embodiments of the invention, the types of the ontology may be classified into dimensions, where dimensions are categories used to group similar concepts. For example, a ‘Date Range’ range can be classified as part of a ‘Time’ dimension, as can a ‘hasEffectiveDate’ property; similarly, a “reimbursementRate” range may be classified as part of a ‘Monetary’ dimension. In this way, semantically-linked types may be grouped together.

In some embodiments, once the system has identified the changes, the system may identify corresponding types within the dimensions to construct database queries. For example, given the following dimensions:

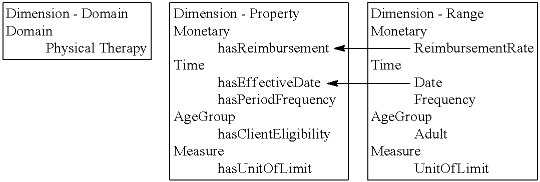

The system may walk the dimensions from range to property to find the correct property to construct the query. For example, where the reimbursement rate and the effective date have changed between two compared documents, the system may look for the property within the monetary dimension of the property dimensions that corresponds to ReimbursementRate, which is in the monetary dimension of the range dimensions. In this case, the corresponding property is hasReimbursement. Likewise the system may search for the corresponding property for the Date range, which in this case would be the hasEffectiveDate property. The system may then use these identified properties to construct a SPARQL database query as follows:

SELECT DISTINCT

? policy WHERE { ? policy
<http://abc.com/hasReimbursement> ?ReimbursementRate .
? policy <http://abc.com/hasEffectiveDate> ?date.
? policy <http://abc.com/hasDomain> ‘Physical Therapy’.

This database query may return changes to the reimbursement rate relevant to the financial interests of the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify areas within a text document that have changed in a revision or update, identify the precise semantic nature of the changes, and anchor the changes to the exact policy text that describes the changes.

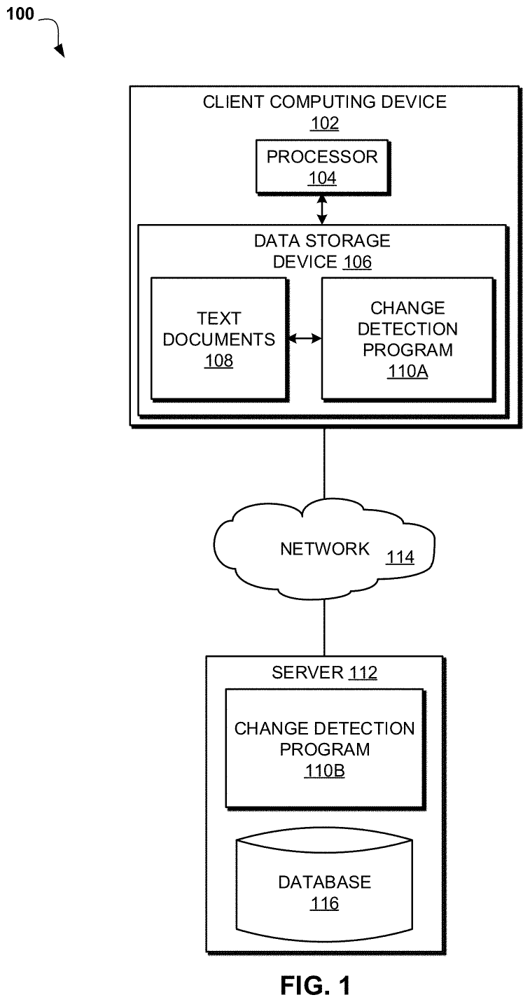

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

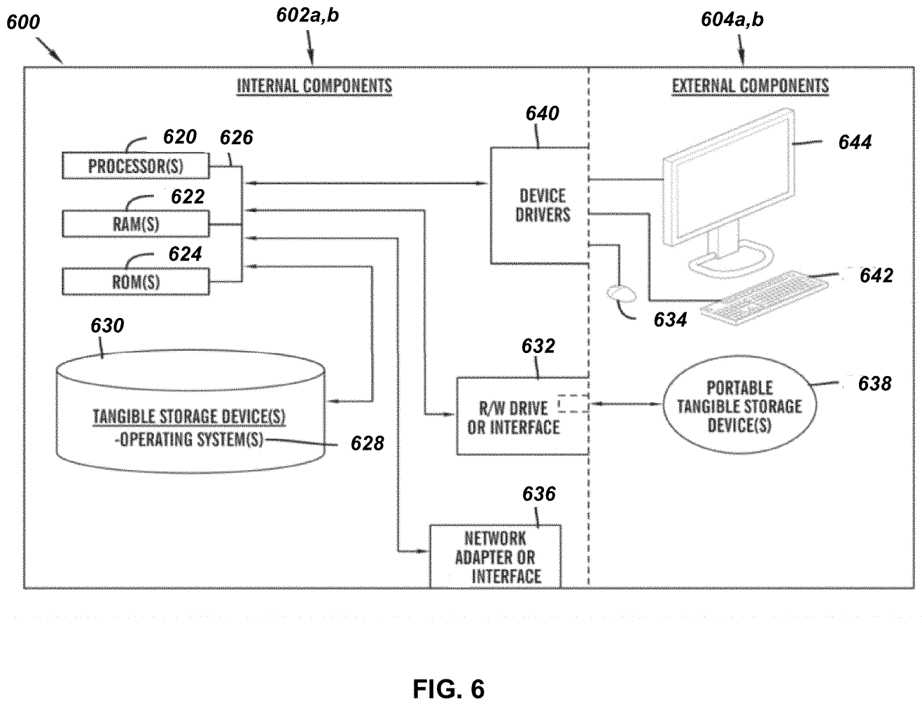

Client computing device 102 may include a processor 104 and a data storage device 106 that is enabled to host and run a change detection program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 6, the client computing device 102 may include internal components 602a and external components 604a, respectively.

The server computer 112 may be a laptop computer, netbook computer, personal computer (PC), a desktop computer, or any programmable electronic device or any network of programmable electronic devices capable of hosting and running a change detection program 110B and a database 116 and communicating with the client computing device 102 via the communication network 114, in accordance with embodiments of the invention. As will be discussed with reference to FIG. 6, the server computer 112 may include internal components 602b and external components 604b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

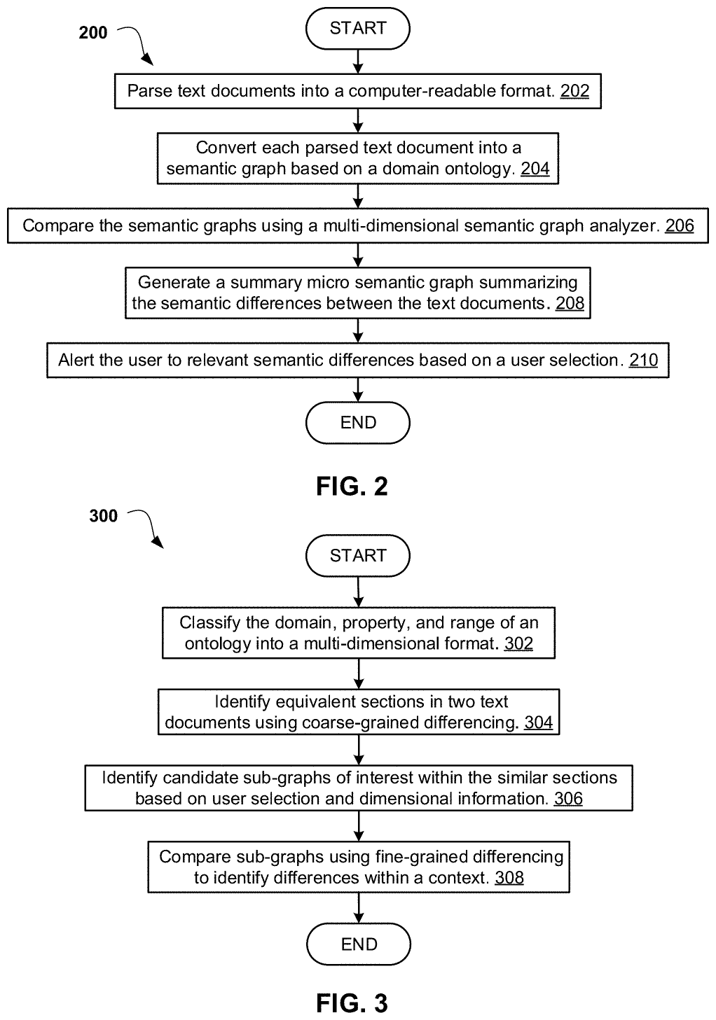

According to the present embodiment, the change detection program 110A, 110B may be a program enabled to identify areas within a text document that have changed in a revision or update, identify the precise semantic nature of the changes, and anchor the changes to the exact policy text that describes the changes. The change detection may be located on client computing device 102 or server 112 or on any other device located within network 114. Furthermore, change detection may be distributed in its operation over multiple devices, such as client computing device 102 and server 112. The change detection method is explained in further detail below with respect to FIG. 2.

Text documents 108 may be two or more text-based documents where at least one document is an improved, revised, updated or otherwise modified but not wholly different version of another document. While embodiments are presented herein primarily with reference to the field of medical insurance policies, one skilled in the art would recognize that the invention is enabled for any revised or updated text documents, regardless of the documents' context or purpose. Text documents 108 may be located on data storage device 106, database 116, any storage medium connected to network 114, or any combination thereof.

Referring now to FIG. 2, an operational flowchart illustrating a change detection process 200 is depicted according to at least one embodiment. At 202, the change detection program 110A, 110B parses two or more text documents into a computer readable format. The change detection program 110A, 110B may parse the text, which may be in the form of a .pdf file, into a computer readable format, such as text, html, et cetera, utilizing any of a multitude of known programs or services.

At 204, the change detection program 110A, 110B converts each parsed text document into a semantic graph based on an ontology. The semantic graph may be a knowledge graph that represents concepts expressed in the texts (for example, Physiotherapy Service, Unit Limitations, et cetera) as well as the relationships between those concepts (for example, that there is a limit to the units of services that a provider can claim for Physiotherapy Services and the value of that Unit Limitation is 20 units). The structure of the semantic graph may be provided by an ontology that is defined by subject matter experts. The ontology pertains to the field associated with the text documents to be compared. For instance, when the texts are in the medical insurance field, the system may retrieve an ontology pertaining to medical insurance. The ontology may also pertain, for instance, to the fields of automotive documents, wine recipes, or any other field where iterative versions of text documents may be sourced. The ontology or ontologies may be pre-defined by subject matter experts, and may include a representation, formal naming, and definition of the properties and ranges that substantiate a field. In some embodiments, the change detection program 110A, 110B may convert a parsed document into a semantic graph according to the example below, where a received document to be compared is a physical therapy insurance document which has an effective date of Jul. 1, 2018, a reimbursement rate of 65%, and is limited to only 20 adult clients per year: the change detection program 110A, 110B recognizes that the document pertains to medical insurance policies, and loads a ontology pertaining to medical insurance policies, a textual representation of which is depicted below:

| Domain | Property | Range |
|---|---|---|
| Policy | isA | Service |
| Policy | hasReimbursement | ReimbursementRate |
| Policy | hasEffectiveDate | Date |
| Policy | hasUnitOfLimit | UnitOfLimit |
| UnitOfLimit | hasPeriodFrequency | Frequency |
| Policy | hasClientEligibility | AgeGroup |

The ontology comprises three types of entity; domain, property, and range. The domain type represents an entity. In this case, the entity is Policy, as this ontology pertains to medical insurance policies, as well as UnitOfLimit, which is another entity within the Policy. The range type represents a value, or a category, that limits or modifies the domain. The property type represents the relationship between a domain and a property. For instance, the domain ‘Policy’ is semantically linked to the range ‘Date’ by the property ‘hasEffectiveDate.’ The ontology generally defines the domains and ranges of a field, and the relationship between them in the form of a property. The system then creates a semantic graph by first inserting specific domains and ranges from the text. An exemplary textual representation of the semantic graph describing the physical therapy policy document is illustrated below:

| Domain | Property | Range |
|---|---|---|
| Policy | IsA | Physical Therapy |
| Physical Therapy | hasReimbursement | 65% |
| Physical Therapy | hasEffectiveDate | Jul. 1, 208 |
| Physical Therapy | hasUnitOfLimit | 20 |
| 20 | hasPeriodFrequency | Per Year |
| Physical Therapy | hasClientEligibility | Adult |

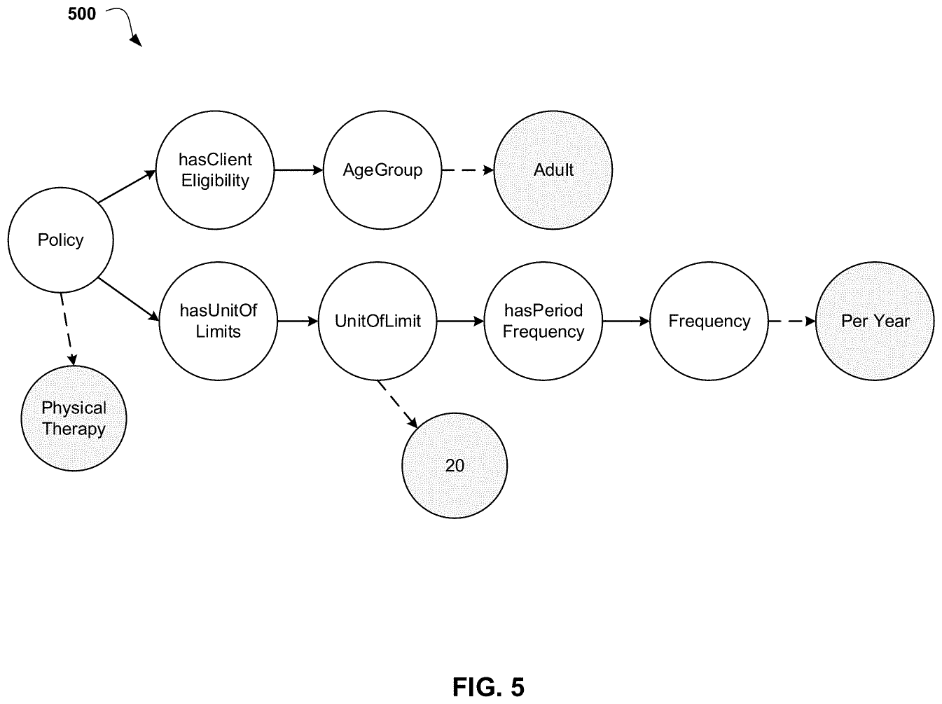

In constructing the semantic graph, the system has fitted specific entities and relationships from the text into the definitions provided by the ontology. For example, change detection program 110A, 110B has identified that the policy is physical therapy, since only adult clients are eligible then Physical Therapy hasClientEligibility Adult, et cetera. A knowledge graph representation of this semantic graph is depicted in FIG. 5.

At 206, the change detection program 110A, 110B compares the semantic graphs using a multi-dimensional semantic graph analyzer. The multi-dimensional semantic graph analyzer is a process which utilizes dimensions from an ontology and a semantic graph to compare the text documents. The comparing method is explained in further detail below with respect to FIG. 3.

At 208, the change detection program 110A, 110B generates a summary micro semantic graph summarizing the semantic differences between the two documents. The change detection program 110A, 110B may further retain the original context, such as by including identifying commonalties such as title, code group, label, et cetera. The summary micro semantic graph summarizing the changes of two policies, Policy1 and Policy2, may look as follows:

Policy1

:Policy 2008

:procedure code group 2935

:rdfs:label “2935”, “Occupational therapy evaluation”;

:hasReimbursementRate “70%”

:hasEffectiveDate “Jul. 1, 2008”

Policy2

:Policy 2009

:procedure code group 2935

:rdfs:label “2935”, “Occupational therapy evaluation”;

:hasReimbursementRate “65%”

:hasEffectiveDate “Apr. 15, 2009”

In some embodiments, the summary micro semantic graph may be displayed to a user interested in learning about the differences, or may be used in conjunction with additional information, for instance user supplied financial information, to calculate the implications of the changes. For example, by calculating the final impact of changes to the reimbursement rate of the user (5%) given the total cost of policy services during the year in question.

At 210, the change detection program 110A, 110B alerts the user to relevant semantic differences based on a user selection. The user may pre-select areas of interest, and the change detection program 110A, 110B may consider such selected areas to be relevant, or ‘of interest,’ and may send alerts when changes occur within those areas of interest. For example, a user may specify that she is interested in identifying differences that are ‘Financial’ in nature; change detection program 110A, 110B may accordingly alert the user when her life insurance rate changes. The change detection program 110A, 110B may alert the user by transmitting the subset of the semantic differences to the user device, where the user device is any client computing device 102 operated or owned by a user. Users may be individual human users or may be services, corporations, or other entities interacting with or operating the change detection program 110A, 110B.

Referring now to FIG. 3, an operational flowchart illustrating a comparing method 300 is depicted according to at least one embodiment. At 302, the multi-dimensional semantic analyzer classifies the domain, property, and range of an ontology into a multi-dimensional format. Dimensions may be categories used to group similar concepts. For example, a ‘Date Range’ range can be classified as part of a ‘Time’ dimension, as can a ‘hasEffectiveDate’ property; similarly, a “reimbursementRate” range may be classified as part of a ‘Monetary’ dimension. In this way, semantically-linked types may be grouped together. In some embodiments, default dimensions may be pre-defined, such as who, when, where, what. Such default dimensions may be represented by the corresponding dimensions of AgeGroup, Time, Geography, Monetary.

| Domain | Property | Range |
|---|---|---|
| Policy | isA | Service |
| Policy | hasReimbursement | ReimbursementRate |
| Policy | hasEffectiveDate | Date |
| Policy | hasUnitOfLimit | UnitOfLimit |
| UnitOfLimit | hasPeriodFrequency | Frequency |
| Policy | hasClientEligibility | AgeGroup |

In the above exemplary ontology, the domain, property, and range may be classified into the following dimensions, based on type (domain, property, range):

| | | |
|---|---|---|
| Dimension - Domain | Dimension - Property | Dimension - Range |
| Service | Monetary | Monetary |
| Policy | hasReimbursement | ReimbursementRate |
| Measure | Time | Time |
| UnitOfLimit | hasEffectiveDate | Date |
| | hasPeriodFrequency | Frequency |
| | AgeGroup | AgeGroup |
| | hasClientEligibility | Adult |
| | Measure | Measure |
| | hasUnitOfLimit | UnitOfLimit |

At 304, the multi-dimensional semantic analyzer uses coarse-grained differencing to identify similar sections in two text documents. Coarse-grained differencing may be any method of identifying sections from the two text documents being compared that are similar or equivalent, for instance text-similarity scoring.

At 306, the multi-dimensional semantic analyzer identifies candidate sub-graphs of interest within the similar sections based on user selection and dimensional information. The sub-graphs may be smaller, discrete semantic graphs pertaining to individual sections of text identified by the coarse-grained differencing, rather than a document as a whole. The change detection program 110A, 110B may identify candidate sub-graphs of interest within the similar sections by examining the sub-graphs pertaining to two equivalent sections of the text documents being compared, and automatically constructing database queries to select sub-graphs belonging to a dimension that a user has expressed interest in via a pre-selection of that dimension. As an example, two sections of text documents pertaining to a medical insurance policy and identified as equivalent through coarse-grained differencing, Section A and Section B, are provided below. Section B is a later revision of Section A, and the changes between them are underlined. Section A is worded and formatted as follows:
As of Jul. 1, 2007, providers of physician and practitioner services; outpatient services (including outpatient hospitals, federal qualified health centers, rural health centers and dialysis centers); emergency dental services, independent laboratory and x-ray services; medical supply services; hospice and home health services; and emergency transportation services will be reimbursed at 60% of the appropriate Medicaid reimbursement. [Effective Jul. 30, 2007]
As of Nov. 1, 2006, pharmacy claims are reimbursed at 70% of the appropriate Medicaid reimbursement. [Effective Jul. 30, 2007]
   Section B is worded and formatted as follows:
As of Apr. 15, 2009, providers of physician and practitioner services; outpatient services (including outpatient hospitals, federal qualified health centers, rural health centers and dialysis centers); emergency dental services, independent laboratory and x-ray services; medical supply services; hospice and home health services; and emergency transportation services will be reimbursed at 65% of the appropriate Medicaid reimbursement. As of Apr. 15, 2009, pharmacy claims are reimbursed at 75% of the appropriate Medicaid reimbursement.
   If the user previously expressed an interest in ‘Financial’ dimension differences, then the multi-dimensional semantic analyzer may identify that the ReimbursementRate range belongs to that dimension. The multi-dimensional semantic analyzer may then query for sub-graphs connected to any ReimbursementRate nodes in the sub-graph; this query will, for example, pick up the rule specifying the reimbursement rate for physiotherapy services in both Section A and Section B. The query may also pick up reimbursement rates for hundreds or thousands of other services, some of which will have changed and some of which will have remained the same.

At 308, the multi-dimensional semantic analyzer compares sub-graphs using fine-grained differencing to identify differences within a context. Comparing sub-graphs that contain identical elements (for example, the set of graphs that relate to Physiotherapy Services), the multi-dimensional semantic analyzer performs semantic graph analysis to establish a very precise view of the semantic differences between the sub-graphs, within the context of the selected dimension (e.g., Physiotherapy Services). In some embodiments, the semantic graph analysis may include using a graphing algorithm which identifies the domain, property, and range as a triple, and if two graphs have the same domain, but property and range are different, the graph algorithm may detect and mark the differences. The differences may be anchored to the text in that the entities are identified in the text, and any changes in that entity within the text are tracked, and the changes remain associated with the text; for instance, in a revision the reimbursement rate may change from 75% to 70%. Although the wording may differ between revisions, the multi-dimensional semantic analyzer may understand the wording to be describing reimbursement rate. For example, the 2017 document may say “refund 75%,” while the 2018 document may read “reimburse a patient at 70%”; the multi-dimensional semantic analyzer will understand that these two phrasings are equivalent, and both describe reimbursement rates.

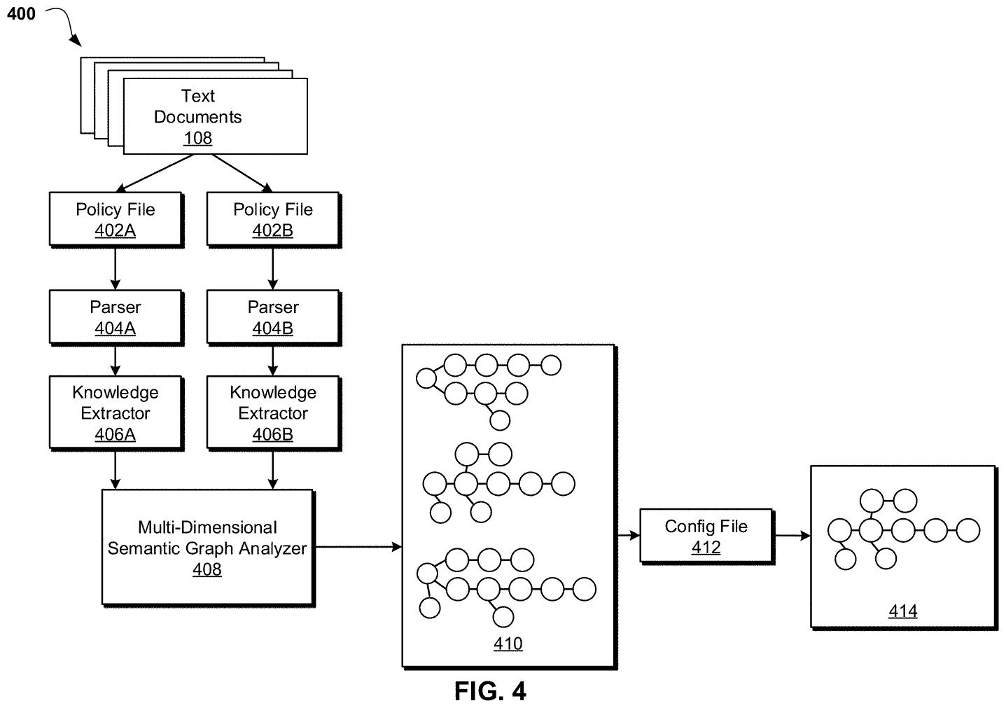

Referring now to FIG. 4, a block diagram illustrating the architecture of a change detection system 400 is depicted according to at least one embodiment. Policy Files 402 are text documents from Text Documents 108, where Policy File 402A and Policy File 402B are updated or altered versions of the same original document. Policy File 402A and Policy File 402B are provided as inputs for Parsers 404A and 404B, respectively, which parse the Policy Files 402A, 402B into a computer readable format such as html. The parsed versions of Policy File 402A and Policy File 402B are provided to Knowledge Extractors 406A and 406B, respectively, which identify entities within the text of each Policy File and generate the semantic graph. The semantic graph from Knowledge Extractors 406A and 406B are provided to Multi-Dimensional Semantic Graph Analyzer 408, which analyzes the differences between the entities and sections of text according to comparing method 300 to produce a series of semantic graphs 410. The semantic graphs 410 are the results of the subgraph which is queried by the SPARQL when the system automatically detects semantic differences. For example, a document may talk about different types of dates (e.g. effectiveDate, endDate, applicableDate, et cetera); if there are changes to any of these, the changes will be in graphs 410. The config file 412 contains user preferences, and semantic graphs 410 are filtered according to the user preferences to produce filtered graphs 414, which are ready to be displayed to the user or trigger an alert. In some embodiments, knowledge extractors 406A and 406B may be components or embody functionalities within the multi-dimensional semantic graph analyzer 408.

Referring now to FIG. 5, an operational flowchart illustrating a semantic graph 500 is depicted according to at least one embodiment. Semantic graph 500 is a knowledge graph representation of the following textual representation of a physical therapy policy document that allows an adult to get 20 units of physical therapy per year:

| Domain | Property | Range |
|---|---|---|
| Policy | IsA | Physical Therapy |
| Physical Therapy | hasUnitOfLimit | 20 |
| 20 | hasPeriodFrequency | Per Year |
| Physical Therapy | hasClientEligibility | Adult |

Where the corresponding ontology is textually represented as follows:

| Domain | Property | Range |
|---|---|---|
| Policy | isA | Service |
| Policy | hasUnitOfLimit | UnitOfLimit |
| UnitOfLimit | hasPeriodFrequency | Frequency |
| Policy | hasClientEligibility | AgeGroup |

Semantic Graph 500 represents the hierarchy of the ontology as a series of nodes, where each node is connected to another node according to its relationship to that node.

It may be appreciated that FIGS. 2-5 provide only an illustration of implementations and do not imply any limitations with regard to how different embodiments may be implemented. Many modifications to the depicted environments may be made based on design and implementation requirements.

FIG. 6 is a block diagram 600 of internal and external components of the client computing device 102 and the server 112 depicted in FIG. 1 in accordance with an embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

The data processing system 602, 604 is representative of any electronic device capable of executing machine-readable program instructions. The data processing system 602, 604 may be representative of a smart phone, a computer system, PDA, or other electronic devices. Examples of computing systems, environments, and/or configurations that may represented by the data processing system 602, 604 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 602a,b and external components 604a,b illustrated in FIG. 6. Each of the sets of internal components 602 include one or more processors 620, one or more computer-readable RAMs 622, and one or more computer-readable ROMs 624 on one or more buses 626, and one or more operating systems 628 and one or more computer-readable tangible storage devices 630. The one or more operating systems 628 and the change detection program 110A in the client computing device 102, and the change detection program 110B in the server 112 are stored on one or more of the respective computer-readable tangible storage devices 630 for execution by one or more of the respective processors 620 via one or more of the respective RAMs 622 (which typically include cache memory). In the embodiment illustrated in FIG. 6, each of the computer-readable tangible storage devices 630 is a magnetic disk storage device of an internal hard drive. Alternatively, each of the computer-readable tangible storage devices 630 is a semiconductor storage device such as ROM 624, EPROM, flash memory or any other computer-readable tangible storage device that can store a computer program and digital information.

Each set of internal components 602a,b also includes a R/W drive or interface 632 to read from and write to one or more portable computer-readable tangible storage devices 638 such as a CD-ROM, DVD, memory stick, magnetic tape, magnetic disk, optical disk or semiconductor storage device. A software program, such as the change detection program 110A, 110B, can be stored on one or more of the respective portable computer-readable tangible storage devices 638, read via the respective R/W drive or interface 632, and loaded into the respective hard drive 630.

Each set of internal components 602a,b also includes network adapters or interfaces 636 such as a TCP/IP adapter cards, wireless Wi-Fi interface cards, or 3G or 4G wireless interface cards or other wired or wireless communication links. The change detection program 110A in the client computing device 102 and the change detection program 110B in the server 112 can be downloaded to the client computing device 102 and the server 112 from an external computer via a network (for example, the Internet, a local area network or other, wide area network) and respective network adapters or interfaces 636. From the network adapters or interfaces 636 and the change detection program 110A in the client computing device 102 and the change detection program 110B in the server 112 are loaded into the respective hard drive 630. The network may comprise copper wires, optical fibers, wireless transmission, routers, firewalls, switches, gateway computers and/or edge servers.

Each of the sets of external components 604a,b can include a computer display monitor 644, a keyboard 642, and a computer mouse 634. External components 604a,b can also include touch screens, virtual keyboards, touch pads, pointing devices, and other human interface devices. Each of the sets of internal components 602a,b also includes device drivers 640 to interface to computer display monitor 644, keyboard 642, and computer mouse 634. The device drivers 640, R/W drive or interface 632, and network adapter or interface 636 comprise hardware and software (stored in storage device 630 and/or ROM 624).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

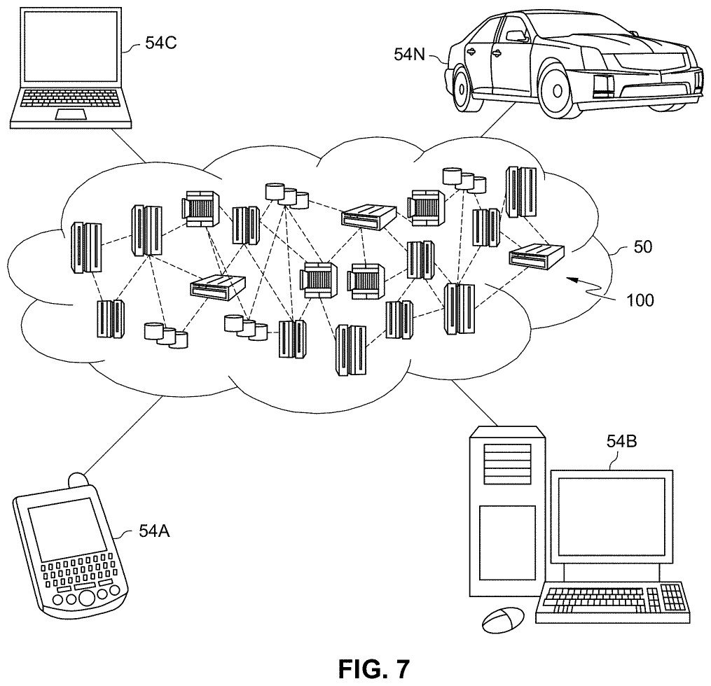

Referring now to FIG. 7, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 100 and cloud computing environment 50 can communicate with any type of computerized device over any type of network and/or network addressable connection (e.g., using a web browser).

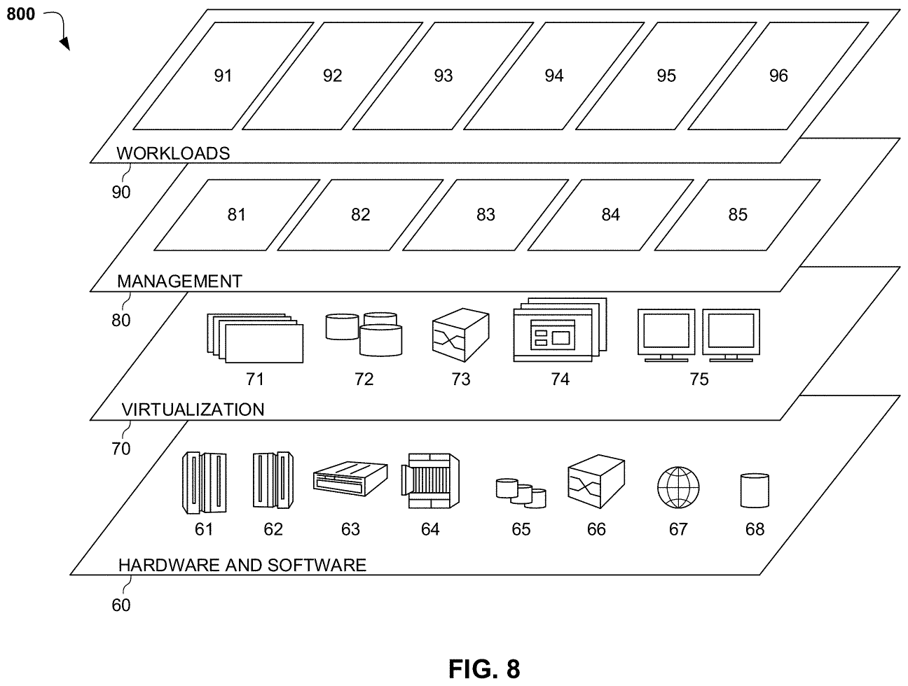

Referring now to FIG. 8, a set of functional abstraction layers 800 provided by cloud computing environment 50 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and change detection 96. The change detection 96 may be enabled to identify areas within a text document that have changed in a revision or update, identify the precise semantic nature of the changes, and anchor the changes to the exact policy text that describes the changes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for semantic text analysis, the method comprising:
converting two or more text documents into a plurality of semantic graphs;
comparing two or more of the plurality of semantic graphs, to identify a plurality of semantic differences between the two or more text documents;
transmitting, based on a user selection, a subset of the semantic differences to one or more user devices.

2. The method of claim 1, wherein comparing two or more of the plurality of semantic graphs further comprises:
classifying a plurality of types of an ontology into dimensions, wherein the ontology is related to the field of the one or more text documents;
identifying, using coarse-grained differencing, two or more equivalent sections of two or more documents;
identifying two or more candidate sub-graphs corresponding to the two or more equivalent sections that match with the user selection; and
comparing, using fine-grained differencing, two or more candidate sub-graphs that match with the user selection to enumerate the one or more semantic differences between the two or more candidate sub-graphs.

3. The method of claim 2, wherein coarse-grained differencing comprises text comparison.

4. The method of claim 2, wherein fine-grained differencing comprises semantic graph analysis.

5. The method of claim 2, wherein dimensions are one or more semantic categories containing one or more semantically linked domains, ranges, or properties of the ontology.

6. The method of claim 1, wherein the subset of changes are anchored to the plurality of text to which they pertain.

7. The method of claim 1, further comprising: generating a micro summary semantic graph based on the subset of semantic differences.

8. A computer system for semantic text analysis, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
converting two or more text documents into a plurality of semantic graphs;
comparing two or more of the plurality of semantic graphs, to identify a plurality of semantic differences between the two or more text documents;
transmitting, based on a user selection, a subset of the semantic differences to one or more user devices.

9. The computer system of claim 8, wherein comparing two or more of the plurality of semantic graphs further comprises:
classifying a plurality of types of an ontology into dimensions, wherein the ontology is related to the field of the one or more text documents;
identifying, using coarse-grained differencing, two or more equivalent sections of two or more documents;
identifying two or more candidate sub-graphs corresponding to the two or more equivalent sections that match with the user selection; and
comparing, using fine-grained differencing, two or more candidate sub-graphs that match with the user selection to enumerate the one or more semantic differences between the two or more candidate sub-graphs.

10. The computer system of claim 9, wherein coarse-grained differencing comprises text comparison.

11. The computer system of claim 9, wherein fine-grained differencing comprises semantic graph analysis.

12. The computer system of claim 9, wherein dimensions are one or more semantic categories containing one or more semantically linked domains, ranges, or properties of the ontology.

13. The computer system of claim 8, wherein the subset of changes are anchored to the plurality of text to which they pertain.

14. The computer system of claim 8, further comprising: generating a micro summary semantic graph based on the subset of semantic differences.

15. A computer program product for semantic text analysis, the computer program product comprising:
one or more computer-readable tangible storage medium and program instructions stored on at least one of the one or more tangible storage medium, the program instructions executable by a processor to cause the processor to perform a method comprising:
converting two or more text documents into a plurality of semantic graphs;
comparing two or more of the plurality of semantic graphs, to identify a plurality of semantic differences between the two or more text documents;
transmitting, based on a user selection, a subset of the semantic differences to one or more user devices.

16. The computer program product of claim 15, wherein comparing two or more of the plurality of semantic graphs further comprises:
classifying a plurality of types of an ontology into dimensions, wherein the ontology is related to the field of the one or more text documents;
identifying, using coarse-grained differencing, two or more equivalent sections of two or more documents;
identifying two or more candidate sub-graphs corresponding to the two or more equivalent sections that match with the user selection; and
comparing, using fine-grained differencing, two or more candidate sub-graphs that match with the user selection to enumerate the one or more semantic differences between the two or more candidate sub-graphs.

17. The computer program product of claim 16, wherein coarse-grained differencing comprises text comparison.

18. The computer program product of claim 16, wherein fine-grained differencing comprises semantic graph analysis.

19. The computer program product of claim 16, wherein dimensions are one or more semantic categories containing one or more semantically linked domains, ranges, or properties of the ontology.

20. The computer program product of claim 15, wherein the subset of changes are anchored to the plurality of text to which they pertain.
